(19) United States
(12) Patent Application Publication
(10) Pub. No.: US 2015/0201003 A1
(43) Pub. Date: Jul. 16, 2015

(54) SYSTEM AND METHOD FOR UTILIZING SCRIPT LOGIC IN CONNECTION WITH AN INSTALLED ENTERPRISE SERVICE APPLICATION

(71) Applicant: NetApp, Inc., Sunnyvale, CA (US)

(72) Inventor: Gary King, Los Altos, CA (US)

(73) Assignee: NetApp, Inc., Sunnyvale, CA (US)

(21) Appl. No.: 14/155,229

(22) Filed: Jan. 14, 2014

(51) Int. Cl. H04L 29/08; G06F 17/22

(52) U.S. Cl. CPC H04L 67/10; G06F 17/2247

(57) ABSTRACT

A client application is installed on a computing device. The client application is operable to implement a set of services for use with an enterprise network. The computing device accesses the enterprise network using the client application, and receives and processes script logic from the enterprise network. The script logic is executed through the client application to provide at least one of a user-interface or workflow for the set of services.

### TECHNICAL FIELD

Examples described herein relate to a system and method for utilizing script logic in connection with an installed enterprise service application.

### BACKGROUND

Enterprise networks often utilize client applications that require user interaction and involvement beyond an initial authentication step. Such applications can provide various services for users of the enterprise network, including authentication, file repository managers, intranet applications, file viewing or editing, and messaging. Typically, however, such applications are generic (or non-specific) in user-interface content and workflow as between enterprise networks, and further as between different classes of users of a particular enterprise network.

### BRIEF DESCRIPTION OF THE DRAWINGS

FIG. 1 illustrates a system for utilizing resources of an enterprise network, according to an aspect.

FIG. 2 illustrates an application platform that can be installed on a computing device for use when accessing an enterprise network, according to an aspect.

FIG. 3 illustrates a method for providing access to an enterprise network using a web-application, according to an aspect.

FIG. 4 illustrates a method for using an enterprise service application in connection with a web-application, according to another aspect.

FIG. 5 is a block diagram that illustrates a computer system in which embodiments described herein may be implemented.

### DETAILED DESCRIPTION

In one aspect, a client application is installed on a computing device. The client application is operable to implement a set of services for use with an enterprise network. The computing device accesses the enterprise network using the client application, and receives and processes script logic from the enterprise network. The script logic is executed through the client application to provide at least one of a user-interface or workflow for the set of services.

According to another aspect, an enterprise network provides a client application that is installable on a computing device in order to provide the computing device with a set of services for use with an enterprise network. The client application associates a local link with each service in the set of services, so that each service in the set of services can be triggered by the application running on the computing device using the local link. Once installed, the client application can be configured to process script logic provided by the enterprise network. The client application can be receptive to script logic, including logic that triggers service using the associated local link for that service. A shell for the application is configured to implement a user-interface or workflow for each service in the set of services by communicating with and receiving data from the user-interface application.

Still further, examples described herein provide a system and method for providing access to an enterprise network. In one aspect, script logic is provided for download by a computing device that accesses the enterprise network using a client application that is resident on the computing device. The client application can carry instructions for implementing services for use with the enterprise network. The script logic is structured to access a service of the enterprise network when the client application is installed on the computing device. One of a user-interface or workflow is provided through execution of the script logic with the client application. In this way, the user-interface or workflow can be provided in connection with one of more of the services provided by the client application.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component can exist in a hardware component independently of other modules/components or a module/component can be a shared element or process of other modules/components, programs or machines. A module or component may reside on one machine, such as on a client or on a server, or may alternatively be distributed among multiple machines, such as on multiple clients or server machines. Any system described may be implemented in whole or in part on a server, or as part of a network service. Alternatively, a system such as described herein may be implemented on a local computer or terminal, in whole or in part. In either case, implementation of a system may use memory, processors and network resources (including data ports and signal lines (optical, electrical etc.)), unless stated otherwise.

Furthermore, one or more embodiments described herein may be implemented through the use of instructions that are executable by one or more processors. These instructions may be carried on a non-transitory computer-readable medium. Machines shown in figures below provide examples of processing resources and non-transitory computer-readable mediums on which instructions for implementing one or more embodiments can be executed and/or carried. For example, a machine shown for one or more embodiments includes processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and tablets) and magnetic memory. Computers, terminals, and network-enabled devices (e.g. portable devices such as cell phones) are all examples of machines and devices that use processors, memory, and instructions stored on computer-readable mediums.

System Overview

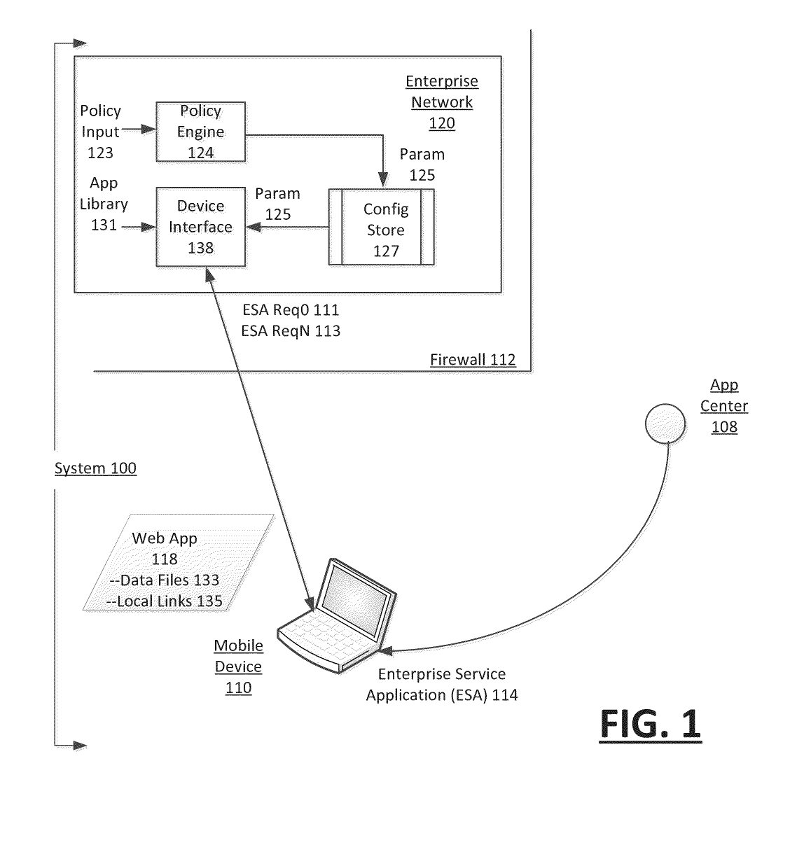

FIG. 1 illustrates a system for utilizing resources of an enterprise network, according to an aspect. With reference to FIG. 1, an enterprise system 100 includes a mobile device 110 and an enterprise network 120. The mobile device 110 is configured with installation of an enterprise service application (ESA) 130 that provides a set of core services for use with the enterprise network 120. The mobile device 110 executes the ESA 130 in order to access and utilize core services in a particular network environment, such as with the specific enterprise network 120. The enterprise network 120 can provide a user-interface application to configure operation of the ESA 130. In one implementation, the enterprise network 120 utilizes script logic that is downloaded or otherwise received through the ESA 130. The script logic provides features, content and/or other service that affects the user-experience with respect to the core services and the enterprise network 120. Among other aspects, the configurations provided to the ESA 130 by the script logic can be created, selected or otherwise specified by the administrator of the enterprise network 120. In one implementation, the administrator can also use the script logic to configure performance of the ESA 130 for different users or devices. The variations in the performance of the ESA 130 amongst devices or users of the enterprise network 120 can be based on a parameter such as the individual user, the class of user, or the device in use. In variations, the script logic configurations can be based on other parameters, such as user activity or geographic region.

In more detail, the mobile device 110 can correspond to any connected device that is capable of roaming and connecting to the enterprise network 120. By way of example, the mobile device 110 can correspond to a tablet, a multifunctional cellular telephony device, a laptop or other portable computing device. The mobile device 110 can access the enterprise network 120 over a network such as the Internet, and across one more firewalls 112.

In one implementation, the ESA 130 is provided by a third-party (e.g., application center 108), and includes a generic set of core services that can be used with any network environment. For example, the ESA 130 can be compiled and distributed with a default set of configurations, for use with enterprise networks or other networked environments. When implemented for the specific enterprise network 120, the ESA 130 is configured in accordance with, for example, the resources, policies and other considerations of the enterprise network 120. Client devices of the enterprise network 120 can download the ESA 130 from, for example, the application center 108. Examples described herein recognize however, that while the ESA 130 provides a generic set of core services that can be configured for the enterprise network 120, conventional approaches have precluded the enterprise network 120 from configuring content or workflow that affects the user experience. In contrast to conventional approaches, the enterprise network 120 can make available for download script logic that generates or otherwise configures the user-interface content, functionality and workflow provided through execution of the ESA 130. The script logic can also control the workflow of the core services so that, for example, implementation of the core services differentiates from a default implementation.

Among other benefits, the script logic interacts with the ESA 130 and enables the enterprise network 120 to configure implementation of the core set of services so as to enable administrator specific user-experience elements, functionality and content. Furthermore, the configurations that are available to the administrator can enable variations in user-experience and workflow based on parameters that distinguish by user, user-class, device or other.

In an example of FIG. 1, a web-application (“web-application 118”) provides an example of the script logic. By way of example, the web-application 118 can be an application implemented in a Hypertext Markup Language (“HTML”) format (e.g., HTML 5). In variations, the web-application 118 includes any application that can implement scripts, including applications that can use structured links, such as Uniform Resource Locators (“URL”). In variations, the web-application 118 can be implemented as a LUA or PYTHON application. The mobile device 110 can access the enterprise network 120 in order to download the web-application 118. Initially, the mobile device 110 can install the ESA 130, then use the ESA 130 to initiate one or more ESA requests 111, 113 from the enterprise network 120. In a first instance, the mobile device 110 can use the ESA 130 to tunnel access through the firewall 112 and signal a first ESA request 111. The first ESA request 111 can also identify an account, user or device of the mobile device 110.

In response to receiving the ESA request 111, the enterprise network 120 can signal the web-application 118 to the mobile device 110. For example, the ESA request 111 can identify the user, and the enterprise network 120 can implement logic to identify whether the user is in need of script logic (e.g., web-application 118) in connection with the execution of the ESA 130. The mobile device 110 can receive and install the web-application 118 so that it executes through the ESA 130.

In one implementation, the ESA 130 includes a browser component that can install and run the web-application 118. In this way, the ESA 130 is installed on the mobile device 110, and then used to access the enterprise network 120. The enterprise network 120 can return the web-application 118 as a response to the mobile device 110 signaling the ESA request 111.

The web-application 118 can reside on the mobile device 110 as a session-based component. For example, the ESA 130 can receive and execute the web-application 118 while the ESA 130 is connected to the enterprise network 120. In a variation, the web-application 118 can be persistently stored and installed on the mobile device 110. In such a variation, the web-application 118 can execute in subsequent instances when the ESA 130 is used to access the enterprise network 120. As an additional variation, the web-application 118 can be executable with the ESA 130 in an offline mode.

Once installed, the web-application 118 can interface with the ESA 130 on the mobile device 110 in order to provide configurations in the form of user-interface content, user-interface functionality and/or workflow for the ESA 130. The configurations provided by the web-application 118 can be for some or all of the core services provided by the ESA 130. More specifically, aspects of the user-interface for the ESA 130, such as the content, functionality or workflow can be provided and controlled by the web-application 118.

In one aspect, the web-application 118 is provided or associated with data files and configurations that are selected or determined on the enterprise network 120, based on a parameter communicated through the ESA 130 (e.g., via ESA request 111). For example, the associated data files and configurations can be selected at least in part from the identifier signaled with the ESA request 111. In this way, the enterprise network 120 can configure the user-interface content, functionality and/or workflow of the ESA 130 for the user or class of user.

The web-application 118 can be generated either manually or programmatically for the mobile device 110. When generated, the web-application 118 can be provided and/or associated with a select set of data files 133. By way of example, the web-application 118 can be generated as an HTML file, and more specifically, as an HTML 5 file. The selection of data files 133 that are to be provided and/or associated with the web-application 118 can be determined in part from the user or class of user. For example, the data files 133 can be selected for the user based on the user credentials, as communicated through the ESA request 111. The data files 133 can include content (e.g., branding content, administrator or system messages), functionality and/or workflow instructions regarding the implementation of one or more core services.

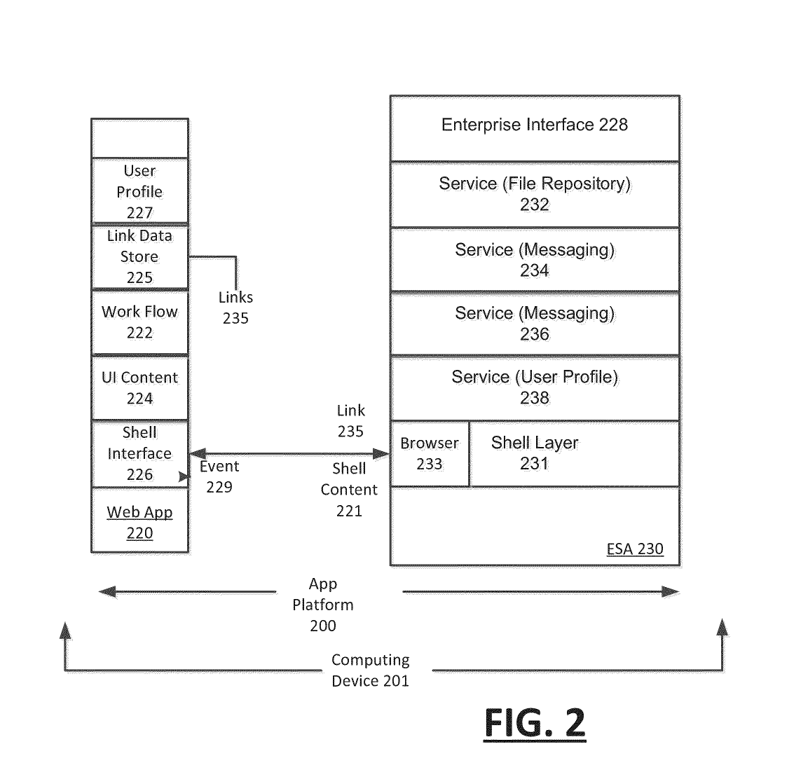

In one implementation, the web-application 118 incorporates local links 135 (e.g., see FIG. 2) that reference services and functionality provided with the core services of ESA 130. Additionally, the web-application 118 can be provided or associated with logic to control which services are triggered and what content is displayed to the user when the core services are accessed on the mobile device 110. By way of example, the web-application 118 can utilize data files 133 and local links 135 to control execution of the ESA 130 on the mobile device 110 in order to (i) display enterprise-specific content (e.g., branding content) to all users of the enterprise network, (ii) display user or class specific content, such as messages (e.g., warnings or instructional messages) to users of the enterprise network, and/or (iii) control workflow (e.g., disable some services for select users, determine conditions or triggers when certain services are available, structure of service portal, etc.). In one implementation, the data files 133 and/or local links 135 can be packaged partially or entirely with the web-application 118. Alternatively, the data files 133 and/or local links 135 can reside with the enterprise network 120 (or other network location) and linked to the web-application 118.

By way of example, the web-application 118 can be used to establish a home-page that is user or class-specific. For example, the web-application 118 can specify messages for some users (e.g., welcoming screen, information message, etc.). As a variation, the web-application 118 can be used to establish a portal for resources of the enterprise network 120, including resources that utilize the core services of the ESA 130. The portal can structure the core services of the ESA 130 into hierarchy using data specified by the administrator of the enterprise network 120.

In one variation, the data files 133 of the web-application 118 are programmatically determined on the enterprise network based on policy determinations. In one implementation, the enterprise network 120 includes a policy engine 124 that receives administrator or policy input 123 and outputs parameters 125 for a configuration store 127. The parameters 125 of the configuration store 127 can identify or correlate to policies, which in turn determine some or all of the data files 133 for use with web-application 118.

A device interface 138 can generate and communicate the web-application 118 to the mobile device 110. In one implementation, the device interface 138 includes an application library 131 for generating the web-application 118 in accordance with parameters 125 for the specific user or user class. The device interface 138 determines the identifier of the user or device, and then uses the identifier to retrieve parameters 125 from the configuration store 127. The parameters 125 can determine or correlate to the data files 133 of the web-application 118 for that user or device. The device interface 138 can also use the application library 131 to generate instructions and data files 133 for the web-application 118. The device interface 138 communicates the instructions for the web-application 118 and associated data files 133 to the mobile device 110.

In one aspect, the web-application 118 operates as a shell for the ESA 130. As illustrated by an example of FIG. 1, the ESA 130 can be installed from a first source (e.g., application store or download store), and the web-application 118 can be installed and made operational when the user subsequently connects to the enterprise network 120. Once the web-application 118 is installed, the workflow and/or user-interface of the ESA 130 can be controlled by the web-application 118. User input or application events generated from the ESA 130 can be communicated to the enterprise network 120 as ESA requests 113, and responses to the ESA requests 113 can be communicated back to the user. Optionally, the web-application 118 can be updated with additional scripts during a given session when requests are made from the mobile device 110.

FIG. 2 illustrates an application platform that can be installed on a computing device for use when accessing an enterprise network, according to an aspect. An application platform 200 can be installed on a computing device 201. By way of example, the computing device 201 can correspond to a mobile device, such as a tablet, laptop, or mufti-functional cellular telephony/messaging device. In an example of FIG. 2, the application platform 200 includes a web-application 220 and an enterprise service application (ESA) 230. The ESA 230 can be installed from a first source (e.g., application download center, enterprise network), and the web-application 220 can be received through the ESA 230 when the computing device 201 accesses the enterprise network 120 (see FIG. 1). In one implementation, the web-application 220 is installed and utilized by the ESA 230 as a session-based component. In another implementation, the web-application 220 is installed and persistently maintained on the computing device 201 for use with the ESA 230. Subsequently, the ESA 230 can utilize the web-application 220 when the ESA 230 is online and/or connected to the enterprise network 120. Still further, the web-application 220 can be installed with files that enable the application's use with the ESA 230 in an offline mode.

In an example of FIG. 2, the ESA 230 includes an enterprise interface 228, and a set of core services, including a file repository service 232, a first messaging service 234 (e.g., email), and a second messaging service 236 (corporate instant messaging). More generally, the ESA 230 can include services for authenticating users, exploring file repositories, using corporate intranet applications, viewing and editing files, and sending or receiving messages.

The ESA 230 can also include a user profile component 238 which includes user-specific data for enabling use of the various core services on the enterprise network 120. Each of the core services 232, 234, 236 can utilize data from the user profile component 238 in order to access the enterprise network 120 and further to utilize resources of the enterprise network 120 (FIG. 1). For example, the messaging service 234 can utilize user data corresponding to a user name and password, as well as a set of preferences. The data from the user profile component 238 can thus enable the messaging service 234 to correspond with an email server of the enterprise network 120 in order to provide an email service.

The structure of the ESA 230 also provides for a shell layer 231. Additionally, an example of FIG. 2 provides for the ESA 230 to include a browser component 233 which can open and operate a web-application. As described below, the shell layer 231 can receive shell content 221 from the web-application 220. The browser 233 can provide a functional environment for receiving and/or executing the web-application 220, as well as other script logic which can be communicated from the enterprise network 120.

In operation, the ESA 230 can authenticate the user and/or device with the enterprise network 120. Once authenticated, the enterprise network 120 can return the web-application 220 to the ESA 230. The ESA 230 can receive and install the web-application 220 using the browser component 233.

According to some examples, the ESA 230 can associate a local link 235 with each core service. Each local link 235 can include an identifier constructed in accordance with a protocol. For example, each local link 235 can be constructed as a Uniform Resource Locator (“URL”), which identifies an application domain and service corresponding to the ESA 230. In one implementation, the local link 235 can be structured as: <local scheme>://service.arguments. The specific syntax that is used can vary. In the example provided, the structure of the local link can identify the application domain as that of the ESA 230, and the service as being one of the core services of the ESA 230. The arguments can identify, for example, the user, user-specific parameters and/or session-specific parameters (e.g., parameters for configurations received when the ESA 230 connects to the enterprise network 120).

The shell layer 231 can be partially or substantially empty of content data. For example, the shell layer 231 can be defined by a set of data structures which identify content (e.g., branding content), user-interface features and workflow processes. By default, some or all of the data structures of the shell layer 231 can be null, and receptive to data provided from the web-application 220.

The web-application 220 can be received from the enterprise network 120 through the browser component 233 of the ESA 230. In one aspect, the web-application 220 can be structured to provide a workflow component 222, a user-interface content 224, a shell interface 226, a link data store 225, and a user profile component 227. In one implementation, the programmatic components of the web-application 220 are packaged and stored on the computing device 201. In a variation, the programmatic components of the web-application 220 are distributed, and the web-application uses associated links and scripts to retrieve and implement functionality as described from the enterprise network 120.

In more detail, the user profile 227 can correspond to data embedded in the web-application 220 for use with the ESA 230. The user profile 227 can include data that is based on policy or permissions regarding what services the user can use. The link data store 225 includes a repository of local links 235 that identify and access resources that are to be used by the application platform 200. In particular, link data store 225 can include local links 235 which identify individual services and components of the ESA 230. In some variations, the link data store 225 can also identify resources of the enterprise network 120 and/or third-party sources, for use in enabling the ESA 230 to access and utilize enterprise network. The workflow component 222 includes logic, including rules and setting, which dictate which service or functionality is to be initiated on the ESA 230 in response to a given event 229 (e.g., user interaction with user inter-face, etc.). The workflow component 222 can be configured by an administrative enterprise network, and further by user profile 227. The logic of the workflow component 222 can be based on the user, class of users, or other information (e.g., type of device). For example, the some or all of the rules provided with the workflow component 222 can be determined by the policy engine or processes of the enterprise network 120. Thus, the workflow component 222 (or alternatively its output) can vary from one user or device to another, depending on the user, class of user, type of device being used, or other variation (e.g., location of the user), as designated by the enterprise network 120. The logic of the workflow component 222 can serve to control the user experience to some or all of the user's interaction with the enterprise network 120. For example, the initial display screen, or any follow-on screens or events can be controlled by the workflow component 222.

Once installed, the shell interface 226 outputs shell content 221 to the ESA 230. When the ESA 230 is launched on a given device, the shell content 221 provides an initial user interface for the enterprise network 120 (see FIG. 1). In particular, shell interface 226 can communicate data that correlates to or identifies content 224 for use with the shell layer 231 of the ESA 230. The UI content 224 can be selected by an administrator or designer of the enterprise network 120. In this way, the use of the ESA 230 can be made specific to the enterprise network 120, even when the ESA 230 is a generic product available to multiple enterprise networks. According to examples, the UI content 224 can correspond to data (e.g., images, video, branding, etc.), and functionality (e.g., hyperlinks). By way of example, the UI content 224 can include a home screen, page border for a core service providing branding or system messages, and/or a portal from which the user can select services from the ESA 230 and/or resources from the enterprise network 120.

In one implementation, the UI content 224 is provided as a file that is stored locally on the computing device, and can be accessed by way of a local link by either the web-application 220 or the ESA 230. In a variation, the UI content 224 can include pointers or links to remote content and data, such as provided to the enterprise network 120. The shell interface 226 can signal shell content 221 in the form of a link, or actual content data accessed through the web-application 220.

The workflow component 222 can include or access logic to select data elements from the UI content 224 for the shell layer 231 of the ESA 230. The data elements can include content items (e.g., branding images, informational messages) and features (e.g., icons, links etc.). The features can enable the user to select a particular service, including core services from the ESA 230, and the features can be correlated to local links of the core services provided through the ESA 230. In this way, the logic of the workflow component 222 can control the user workflow (e.g., user experience with user-interface screens) by controlling when and if functionality for selecting a particular core service is made available to the user via the shell layer 231. The selection of what data elements from the UI content 224 are to be displayed can further be made in response to events. For example, the initial screen of a given user profile may include a particular content, as well features to select a particular service. As another example, the initial screen of the given user profile can include a portal page. The event 229 may correspond to the user's selection of a feature, in which case the workflow component 222 selects a second set of data elements (e.g., user-interface content for selected service, along with links to other service). Thus, the workflow component 222 can include logic that determines when features for a particular event or condition are to be provided to the user through the shell layer 231.

While an example of FIG. 2 depicts the workflow logic 222 as being part of the web-application 220, variations provide for the workflow logic to be determined by the enterprise network 120. For example, a component on the enterprise network 120 can select scripts as part of the web-application 220. Through the selection of scripts, the enterprise network can specify a workflow for the use of the ESA 230 on a given device.

By way of example, the workflow component 222 includes rules or settings that control the initial display screen for a given user when the user accesses the enterprise network 120. The rules or settings of the workflow component 222 can be selected by the enterprise network 120 (e.g., by an administrator) based on the user, class of user, device or policy setting. As an illustration, the initial screen for all users may include branding contact that identifies the proprietor of the enterprise network 120. As another example, the workflow component 222 can include logic that provides for the initial screen for a class of users to include a selected informational message. Still further, the workflow component 222 can regulate what services are available to a particular user or class of users, based on events or conditions. For example, the initial screen that is displayed to the user when the user accesses enterprise network 120 can include icons or other selectable features for accessing some or all of the services.

In a variation, the workflow component 222 can include conditional logic regarding the selection of data elements from the UI content store 224. In this way, the availability of some services may be contingent on events or conditions, including events corresponding to user input. For example, the web-application 220 can provide for the initial screen for the ESA 230 to be a portal page to the enterprise network 120, and the workflow logic can dictate that the selection of services from the ESA 230 can be made through the hierarchy and structure specified with the portal. As still another example, the web-application 220 can provide for an additional layer of authentication to be utilized in order for the user to have a specific service of the ESA 230 or resource of the enterprise network 120. Still further, in some variations, the workflow component 222 can include logic for determining the location of the user, and then determining aspects of the workflow (e.g., what content is to be displayed to the user, what features are made available through the shell layer 231 etc.) based in part on the location.

The shell interface 226 can programmatically interact with the browser component 233 of the ESA 230 and provide the shell content 221. The shell content 221 can include images, text and other content. Additionally, in some implementations, the shell content 221 can also include features for selecting the core services of the ESA 230. In turn, the shell layer 231 of the ESA 230 can record user input, such as the user's selection of a feature. The selection of the local link 235 identified through the selection can be communicated via browser 233 back to the shell interface 226 as event 229. The workflow component 222 can select data elements from the UI content 224 in response to the event 229.

Methodology

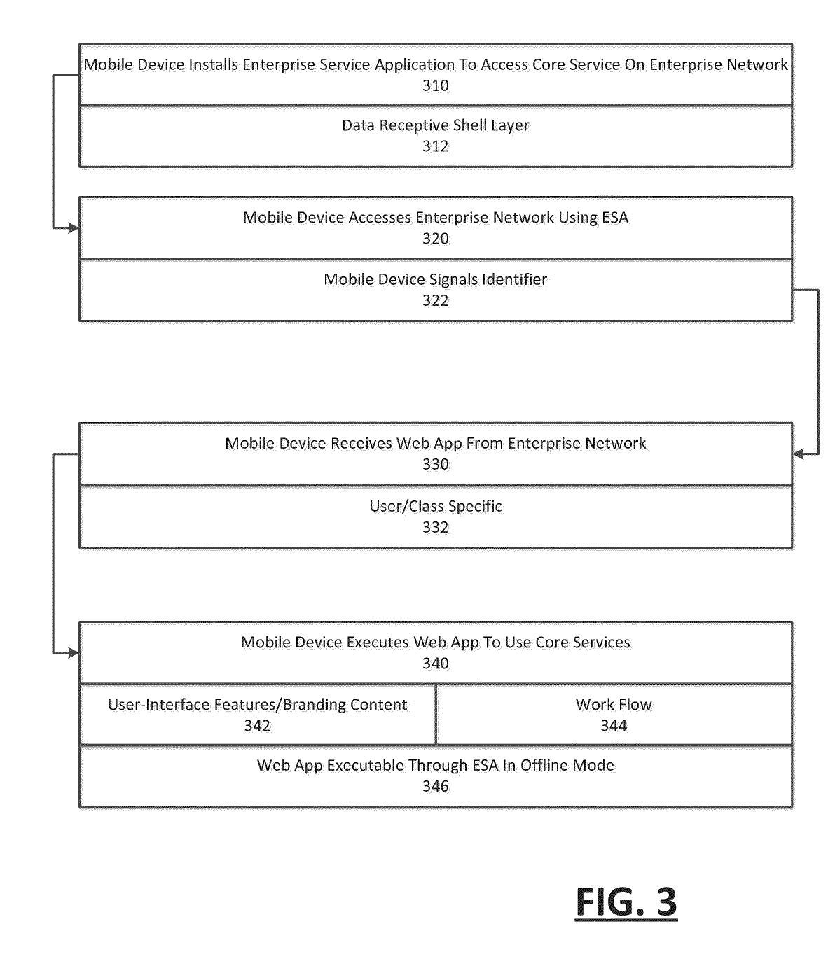

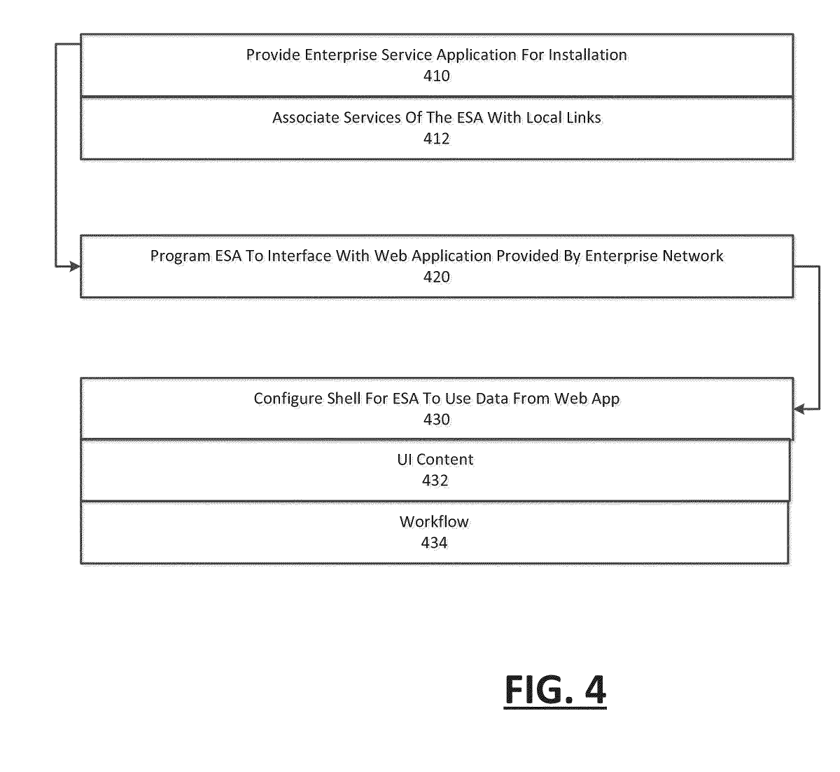

FIG. 3 illustrates a method for providing access to an enterprise network using a web-application, according to an aspect. FIG. 4 illustrates a method for using an enterprise service application in connection with a web-application, according to another aspect. In describing examples of FIG. 3 or FIG. 4, reference may be made to elements of FIG. 1 or the purpose of illustrating suitable components performing a step or sub-step being described. Accordingly, reference to elements of other figures is intended for illustration purposes.

With reference to FIG. 3, the mobile device 110 installs an enterprise service application for purpose of utilizing core services of the enterprise network (310). The source for the ESA 230 can be selected by, for example, the administrator or vendor of this application. In one implementation, the ESA 230 is provided from application center 108, such as the “App Store”. The ESA 230 can be based on services and functionality that is generic and available to customers that administer enterprise network(s). Furthermore, the customers can implement customizations and configurations for core services provided through the ESA 230. For example, the authentication layer and protocol, the enterprise network policies and/or user account information can, depending on implementation, be incorporated into the ESA 230 either before or after the installation of the program on the device. In this way, ESA 230 can be provided by a third-party, for use by customers that individually operate their own enterprise networks.

Additionally, examples described herein recognize that enterprise networks can benefit from enabling customization to that user experience, apart from the configurations (e.g. policy settings) that are applicable to the core services. Accordingly, the ESA 230 can be implemented with the shell layer 231 to receive shell content 221 and data from another programmatic source (312). In this way, the shell layer 231 of the ESA can be configurable and subject to customizations provided from the enterprise network 120, which can in turn regulate content and workflow to control the user experience. By way of example, the shell layer 231 of the ESA 230 can be empty of content data, or be programmed to replace or augment existing data with data received by the other programmatic source.

Once the ESA 230 is installed, the mobile device 110 can utilize the ESA to access the enterprise network (320). In accessing the enterprise network 120, the mobile device 110 can signal an identifier of the user, user account, device, or other information, in order to determine the shell layer configurations of the ESA 230 (322). In turn, the enterprise network 120 selects the elements (e.g., scripts, content data, workflow logic etc.) of the web-application 220 for the mobile device. Alternatively, enterprise network 120 can select the components for the web-application 118, such as the workflow component 222 or the user interface content store 224.

The mobile device 110 receives the web-application 118 from the enterprise network 120 (330). According to some embodiments, the web-application is an HTML type application, and more specifically, an HTML 5 application. The web-application 118 can be received through the ESA 230. For example, the ESA 230 can implement an encrypted tunnel to receive resources from the enterprise network 120, and such resources can include the web-application 118. As described with an example of FIG. 2, the ESA 230 can include the browser component 233 that can interface and launch the web-application 118.

As further described with other examples, the web-application 118 can include elements or other aspects that are specific to the user, user account, device or other classification as determined by the enterprise network 120 (332). Among other benefits, the use of the web-application 118 enables an administrator of the enterprise network 120 to readily generate user or class specific user interface content in connection with the user operating ESA 230 to access enterprise network. More specifically, the administrator can generate user interface content using an HTML syntax, which requires relatively minimal programming effort. Alternatively, syntax generation tools can be implemented in order to create aspects of the web-application 118. The level of complexity that would otherwise be required for an administrator to interface with the ESA 230 can be avoided. As a result of that ease by which the administrator can configure the web-application 118, the administrator can readily make available some or all of the following features for use with it ESA 230: (i) branding content, (ii) intermittent or temporary informational messages (e.g., shut on warnings), (iii) workflow control (e.g., precluding some users from accessing some services or resources of enterprise network 120, requiring certain users to see a particular content before utilizing a particular core service of the enterprise network 120).

The mobile device 110 can execute the web-application 220 in utilizing the core services through the ESA 230 (340). The web-application 220 can be executed through the browser component 233 of the ESA 230. In one implementation, the execution of the web-application 220 results in the core services being provided with user-interface content, including branding images, text, video, etc. (342). The user-interface content can also include functionality, such as icons or other features which the user can select to trigger a workflow process or content display.

As an alternative or variation, the user-interface content can also include functionality for controlling the workflow of the interfaces and core services provided to the user (346). By way of example, the workflow provided through the web-application can determine an initial display screen for the user, what core services are made available to the user from the initial screen, as well as an order or sequence of core services or user-interfaces. As a first example, the workflow can implement sequencing by display branding content when the user initially accesses the enterprise network, then displaying an information message when a core service is requested. As another example, the workflow can control when features corresponding to local links for the core services are displayed. Thus, for example, features for a select set of core services may be displayed with an initial screen, then features for an alternative or additional set of core services can be displayed for a follow-on screen (e.g., in response to a user input).

With reference to FIG. 4, the ESA 230 is provided for users of enterprise network 120 (410). The ESA 230 can be provided for installation on a variety of devices, including devices that operate different operating system (e.g., a mobile device operating under a particular platform). In one aspect, the ESA 230 can be programmatically structured in accordance with an example of FIG. 2. Accordingly, the ESA 230 can include core services, such as a file system, a messaging service, and/or an authentication service. Additionally, the core services of the ESA 230 can each be associated with a local link (412). The local link can be programmatically utilized to trigger execution of the core service within a platform of the application.

The ESA 230 is configured to communicate and receive instructions and data from web-application 220 (420). In particular the ESA 230 includes a component that directs the client computer to securely communicate with the enterprise network 120 and receive the web-application 220. For example, the ESA 230 can tunnel with the enterprise network 120 to receive the web-application 220. The ESA 230 can be controlled or directed to receive the web-application 220 base on, for example, a policy of the enterprise network 120. For example, the ESA 230 can receive the web-application 220 on the first instance when the ESA 230 accesses the enterprise network 120, or at a subsequent time when the enterprise network 120 requires an update or refresh for the web-application 220.

According to an aspect, the ESA 230 can include a shell structure that is configured to receive shell data from a separate programmatic source (430). Specifically, the shell structure can be configured to receive shell data from the web-application 220. In one implementation, the shell structure receives some or all of the shell data from the enterprise network 120. In one implementation, the shell data can include user-interface content (432). By way of example, the shell content can include content (e.g., branding content, messages) or features (e.g., icons, menus, other selectable features). Some features can be associated with a local link of one of the core services, so that the user can launch a core service using shell data provided from the web-application 220.

As an addition or alternative, the shell data can implement workflow logic (434). In one variation, the workflow logic can control what services can be provided to the user in response to certain events or conditions. For example, the features that are displayed as part of the user-interface can correlate to links to core services. Aspects such as the sequence or conditions in which links to core services are displayed to the user can also be determined by workflow logic. Additionally, aspects such as what services the user experiences when accessing the core service though the enterprise network 120 can be controlled by the workflow logic.

Computer System

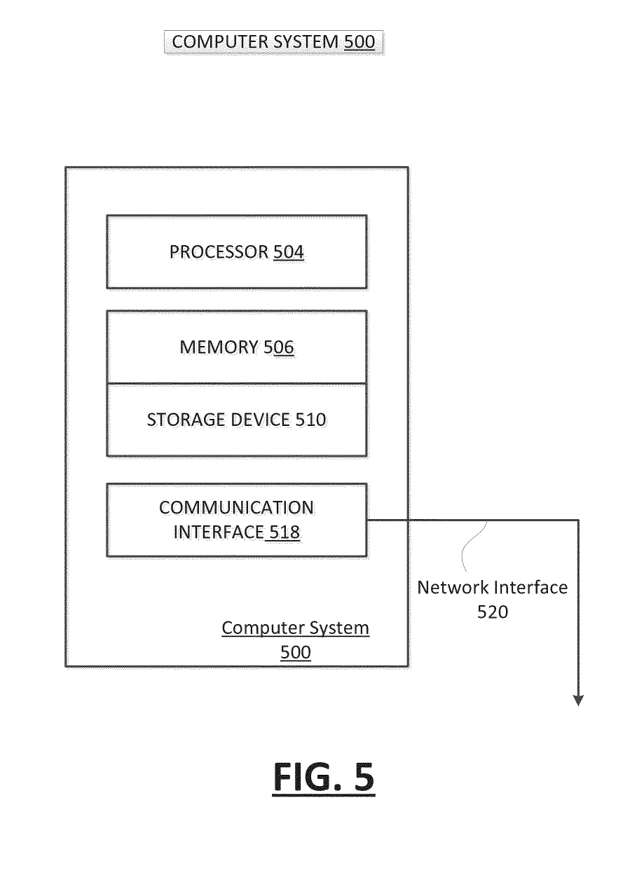

FIG. 5 is a block diagram that illustrates a computer system upon which embodiments described herein may be implemented. For example, a system such as described with FIG. 1 can be implemented on a computer system such as described with an example of FIG. 5. Likewise, an application platform such as described with FIG. 2 can also be implemented with an example of FIG. 5. Additionally, a method such as described with an example of FIG. 3 or FIG. 4 can also be implemented using a system such as described with FIG. 5.

In an embodiment, computer system 500 includes processor 504, memory 506 (including non-transitory memory), storage device 510, and communication interface 518. Computer system 500 includes at least one processor 504 for processing information. The memory 506 can include random access memory (RAM) or other dynamic storage resources, for storing information and instructions to be executed by processor 504. The memory 506 also may be used for storing temporary variables or other intermediate information during execution of instructions to be executed by processor 504. The memory 506 may also include a read only memory (ROM) or other static storage device for storing static information and instructions for processor 504. A storage device 510, such as a magnetic disk or optical disk, is provided for storing information and instructions. The communication interface 518 may enable the computer system 500 to communicate with one or more networks through use of the network link 520 (wireless or wireline).

In one implementation, memory 506 may store instructions for implementing functionality such as described with an example of FIG. 1, or implemented through an example method such as described with FIG. 2. Likewise, the processor 504 may execute the instructions in providing functionality as described with a system such as described with FIG. 1, or with an application platform such as described with FIG. 2, or still further, with methods such as described with FIG. 3 or FIG. 4.

Embodiments described herein are related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for operating a computing device, the method being implemented by one or more processors and comprising:
executing a client application that is installed on the computing device, in order to implement a set of services on the computing device for use with an enterprise network;
accessing, on the computing device, the specific enterprise network using the client application;
receiving, when accessing the specific enterprise network on the computing device, script logic; and
executing the script logic through the client application to provide at least one of a user-interface or workflow for the set of services.

2. The method of claim 1, wherein the user-interface application includes a user profile, and wherein executing the script logic includes providing the user-interface or workflow that is configured, based on the user profile, to be specific to a user or class of user.

3. The method claim 1, wherein executing the script logic includes executing a set of operations that each utilize a local link to a service provided with the client application for use with the enterprise network.

4. The method of claim 1, wherein the script logic includes an HTML 5 application.

5. The method of claim 4, wherein receiving the script logic includes receiving a set of files that correspond to the HTML 5 application, and wherein executing the script logic includes executing the HTML 5 application in an offline mode.

6. The method of claim 1, wherein executing the script logic includes providing a branding content in connection with the computing device accessing the set of services.

7. The method of claim 1, wherein executing the script logic includes sequencing functionality provided by at least one of the services of the set of services.

8. A non-transitory computer-readable medium that stores a set of instructions, the instructions including instructions that when executed by one or more processors, cause the one or more processors to perform operations that include:
provide an application that is installable on a computing device in order to provide the computing device with a set of services for use with an enterprise network;
wherein the application associates, as part of the application, a local link with each service in the set of services, so that each service in the set of services can be triggered by the application running on the computing device using the local link;
configure the application to process, once installed, script logic provided by the enterprise network, the script logic including logic that triggers each service in the set of services using the associated local link for that service; and
configure a shell for the application to implement a user-interface or workflow for each service in the set of services by communicating with and receiving data from the script logic.

9. The computer-readable medium of claim 8, wherein the instructions to configure the shell includes providing the shell to be empty until data is received as a result of execution of the script logic.

10. The computer-readable medium of claim 8, further comprising instructions for causing the computing device to receive the script logic from the enterprise network.

11. The computer-readable medium of claim 8, wherein instructions to configure the application to process script logic includes instructions to receive and process an HTML 5 application that is provided to the application from the enterprise network when the application accesses the enterprise network.

12. The computer-readable medium of claim 8, wherein instructions to configure the shell for the application to implement the user-interface or workflow includes instructions to provide a branding content in connection with the computing device accessing the set of services.

13. The computer-readable medium of claim 8, wherein instructions to configure the shell for the application to implement the user-interface or workflow includes instructions to sequence functionality provided by at least one of the services of the set of services.

14. A method for providing access to an enterprise network, the method being implemented by one or more processors and comprising
providing script logic for download by a computing device that accesses the enterprise network using a client application that is resident on the computing device;
structuring the script logic to access a service of the enterprise network when the client application is installed on the computing device, the service of the enterprise network being provided by the client application; and
providing, through execution of the script logic with the client application, one of a user-interface or workflow for the service provided by the client application.

15. The method of claim 14, further comprising providing the script logic with a set of configurations that are based on a user or class of user, and wherein structuring the script logic to provide at least one of the user-interface or workflow includes structuring the application to provide a specific user-interface or workflow based on the user or class of user.

16. The method of claim 14, further comprising structuring the script logic to include or associate with a set of files that are downloaded onto the computing device through the client application and executable when the computing device is in an offline mode.

17. The method of claim 14, wherein structuring the script logic includes incorporating a set of local links in the script logic, each local link providing a programmatic trigger for signaling the script logic to access and use the service provided through the client application.

18. The method of claim 14, wherein providing the script logic includes providing an HTML 5 application.

19. The method of claim 14, wherein structuring the script logic to provide at least one of the user-interface or workflow includes providing a branding content in connection with the computing device accessing the service.

20. The method of claim 14, wherein structuring the script logic to provide at least one of the user-interface or workflow includes providing a portal that structures the service for use by the computing device with the enterprise network.
